(19) United States
(12) Patent Application Publication
(10) Pub. No.: US 2018/0345586 A1
(43) Pub. Date: Dec. 6, 2018

(54) System and Apparatus for Fiber Reinforced Thermoplastics Joiner

(71) Applicant: Yibo Su, Cambridge, MA (US)

(72) Inventor: Yibo Su, Cambridge, MA (US)

(21) Appl. No.: 15/988,500

(22) Filed: May 24, 2018

Related U.S. Application Data
(60) Provisional application No. 62/513,002, filed on May 31, 2017.

(51) Int. Cl. B29C 65/06; B29C 65/00; B29C 65/78

(52) U.S. Cl. CPC B29C 65/0681; B29C 66/1122; B29C 66/71; B29C 66/836; B29C 65/7847; B29C 66/863; B29C 66/74283; B29C 66/72141

(57) ABSTRACT

A system for, and method of making and repairing a fiber-reinforced component including bonding a first thermoplastic matrix possessing reinforcing fibers distributed therein to a second composite member possessing a thermoplastic matrix with reinforcing fibers distributed therein; and metals and more particularly a method and apparatuses for joining fiber reinforced thermoplastics utilizing a combination of heat, force and rotational force.

### CROSS REFERENCE TO RELATED APPLICATION

This application takes priority from and claims the benefit of U.S. Provisional Application Ser. No. 62/513,002, filed on May 31, 2017, the contents of which are herein incorporated by reference.

### BACKGROUND OF THE INVENTION

### Field of the Invention

The present system pertains to apparatuses and methods for joining fiber reinforced thermoplastics to fiber reinforced thermoplastics and metals and more particularly a method and apparatuses for joining fiber reinforced thermoplastics using heat through friction.

### Description of the Related Art

Lightweight structures show remarkable advantages in various industrial sectors and products. A prevalent approach to reducing the weight of structural components is to involve fiber reinforced polymer material into product design and fabrication. Fiber reinforced polymer consists of high strength reinforcement fiber embedded in a polymer matrix which can be either thermoset polymer or thermoplastic polymer. In comparison with thermoset counterparts as mature and widely applied polymer matrices, fiber reinforced thermoplastics have many advantages. Fiber reinforced thermoplastics show higher fracture toughness, i.e. the capability of withstanding crack growth through fiber-matrix interface. This property increases the service life and safety performance of products. Fiber reinforced thermoplastics can be stored with a longer shelf time and more flexible storage condition. Additionally, Fiber reinforced thermoplastics also lower flammability and show higher service temperatures. Once shaped and cured, fiber reinforced thermosets may not be reheated and reshaped. In contrast, fiber reinforced thermoplastics can be reheated and reformed. Therefore fiber reinforced thermoplastics are recyclable and can be processed in more versatile techniques.

As a consequence, fiber reinforced thermoplastics are currently receiving an increasing amount of attention from various industrial sectors. It should be noted that in practical application, particularly for facilitating load introduction, the fiber reinforced thermoplastic component needs to be joined with other components such as another fiber reinforced thermoplastic component or a metal component. This is because the fiber reinforced polymer joint structures have been extensively employed in different industrial sectors and products. For example, the aviation industry has a long history of utilizing fiber reinforced polymer due to its manner of high strength-weight ratio. The most recent released civil aircrafts, the Boeing 787 and Airbus A350, each employ a fiber reinforced polymer fuselage which is fabricated by joining a number of fuselage sections. The application of fiber reinforced polymer in the automotive industry is still limited to the relatively high cost of the fiber reinforced polymer. However, the automotive industry is attempting to reduce the weight of metal automotive structures the strength of which are maintained by joining fiber reinforced polymers to heavily loaded locations. The application of lightweight automotive structures is stimulated by the EU climate action law which urges automotive manufacturers to reduce CO₂ emission of their products by 40% from 2007 to 2021. In civil engineering, fiber reinforced polymers can be joined with steel structures to reinforce the strength of the structure, or to offer a protection of steel structure from corrosion.

Currently, methods of joining fiber reinforced thermoplastic to fiber reinforced thermoplastic and metal can be classified into the following categories: Mechanical fastening, adhesive bonding, co-consolidation and welding. Fiber reinforced thermoplastic components can be mechanically fastened with another fiber reinforced thermoplastic component and metal component by employing fasteners such as screws or rivets. In this case, the inevitable drilling process introduces stress concentration in components, which process also breaks the reinforced fiber of the region adjacent to drilled holes. As a consequence, the service life and safety performance of the joint structure is deteriorated by employing mechanical fastening. In addition, the employment of fasteners will add extra cost and weight to the structural components. Since fiber reinforced thermoplastics are usually served in high temperature applications, therefore conventional adhesives, such as epoxy based adhesive, are not suitable for joining fiber reinforced thermoplastics. In addition, adhesive bonding requires complicated surface preparation prior to joining. The joining processing time, i.e. curing of the adhesive, is quite long and the cost of adhesive is additional to the cost of the structural components.

The co-consolidation process integrates the consolidation of fiber reinforced thermoplastic and the joining of fiber reinforced thermoplastic and fiber reinforced thermoplastic/metal in the same process. This technique employs the thermoplastic resin presented in the fiber reinforced thermoplastic as the adhesive, therefore, no pretreatment of the fiber reinforced thermoplastic is needed and no separate curing time is needed for the adhesive. Since this process integrates joining process with consolidation process which requires sophisticated and expensive equipment with substantive cost of energy and time, the co-consolidation process is more suitable in fabricating a fiber reinforced thermoplastic component with designed joint features, but not as a fast and economic process to join fiber reinforced thermoplastic component or metal component to an existing fiber reinforced thermoplastic component.

The welding technique, also known as the fusion bonding technique, is widely employed in joining fiber reinforced thermoplastics by employing heat to soften the thermoplastic at the fiber reinforced thermoplastic-fiber reinforced thermoplastic interface to achieve a polymer chain inter-diffuse to form joining. However, most of the welding technique requires elaborate and specific equipment and a specific design of the joined components. Some of the techniques and equipment are only applicable for the components with specific geometry. In addition, some welding techniques are not capable to accurately control the welding parameters, which further results in inconsistent welding quality.

Accordingly, the present invention is directed to propose an apparatus which is able to join fiber reinforced thermoplastics with fiber reinforced thermoplastics and metal in an efficient, easy to use and inexpensive manner.

### SUMMARY OF THE INVENTION

The instant system, series of apparatuses and method of usage, as illustrated herein, are clearly not anticipated, rendered obvious, or even present in any of the prior art mechanisms, either alone or in any combination thereof. Thus the several embodiments of the instant apparatus are illustrated herein.

The present invention discloses a method of joining fiber reinforced thermoplastics to fiber reinforced thermoplastics and metals. The present invention further discloses an apparatus, to realize the joining process in combination with the joining method.

An objective of the present invention is to disclose a novel thermoplastics joining method and apparatus to utilize external heat to soften the thermoplastic resin of fiber reinforced thermoplastics prepared for joining. For joining fiber reinforced thermoplastic to fiber reinforced thermoplastic, the softened thermoplastic resin from each fiber reinforced thermoplastic will inter-diffuse with each other to form robust joining. For joining fiber reinforced thermoplastic to metal, the softened thermoplastic resin can flow into the intrinsic surface irregularity of metal to form a strong mechanical keying. It should be noted that, according to different material combination, the existence of oxygen may either promote the joining strength or deteriorate it. Thus the joining may be operated under vacuum atmosphere for better performance.

It is a further objective of the present method and apparatus to utilize a rotating element in contact with a stationary element to generate frictional heat for joining. The stationary element is meanwhile in contact with the fiber reinforced thermoplastic to conduct heat in order to soften the thermoplastic resin underneath the contacted region between rotating element and stationary element. Meanwhile, a quantity of certain downward force is subjected from the rotating element to the stationary element to ensure an intimate contact between the joining regions of joined components; therefore a supporter may be required to support the joined components from displacement caused by the downward force. When the temperature of the joining region cools down due to the removal of the frictional heat, the thermoplastic resin at the joining region will solidify and form the joining.

Another objective of the present system is to disclose a rotating pin driven by an actuator to work as the rotating element. Meanwhile multiple actuators are configured in the apparatus in order to subject downward force and offer multiple degrees of freedom to the pin to facilitate the versatile application conditions.

The instant system also discloses a novel fiber reinforced thermoplastics joining apparatus that is easy to use, easy to install, light weight, inexpensive, and efficient.

There has thus been outlined, rather broadly, the more important features of the fiber reinforced thermoplastics joining method and apparatus in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

The foregoing has outlined the more pertinent and important features of the present system in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

Advantages of the present system will be apparent from the following detailed description of exemplary embodiments thereof, which description should be considered in conjunction with the accompanying drawings, in which having thus described the system in general terms, reference will now be made to the accompanying drawings, which are not necessarily drawn to scale, and wherein:

FIG. 1 illustrates a perspective view of a mechanical schematic of the operation of the joining method.

FIG. 2 illustrates a side view of a mechanical schematic of the operation of the joining method.

FIG. 3 illustrates a perspective view of a mechanical schematic of an alternative operation of the method shown in FIG. 1, in which case the joining process is achieved in a vacuum environment.

FIG. 4 illustrates a perspective view of the apparatus for joining fiber reinforced thermoplastic to fiber reinforced thermoplastic and metal.

FIG. 5A illustrates an exploded view of the joining tool (denoted which is from the dashed box A in FIG. 4) which is the direct implement for joining fiber reinforced thermoplastic to fiber reinforced thermoplastic and, for joining fiber reinforced thermoplastic to metals.

FIG. 5B illustrates an exploded view of an additional joining tool which is the direct implement for joining fiber reinforced thermoplastic to fiber reinforced thermoplastic and, for joining fiber reinforced thermoplastic to metals, illustrating a three actuator alignment including a rotational actuator, a vertical displacement actuator, and a horizontal displacement actuator 164.

FIG. 6 illustrates a perspective view of the alternative rotating elements which should be installed at the position of the dash box B in FIG. 5A.

FIG. 7 illustrates a side view of a mechanical schematic of the first embodiment of the apparatus which is used for repairing defects and damage on fiber reinforced thermoplastic aero structures.

FIG. 8 illustrates a side view of a mechanical schematic of the second embodiment of the apparatus which is used for joining a metal feature to fiber reinforced thermoplastic aero structures.

FIG. 9 illustrates a side view of a mechanical schematic of the third embodiment of the apparatus which is used for joining fiber reinforced thermoplastic to reinforced metal automotive structures.

FIG. 10 illustrates a side view of a mechanical schematic of the fourth embodiment of the apparatus which is used for joining fiber reinforced thermoplastic to repair damaged metal civil structures.

FIG. 11 illustrates a flow chart of the method for joining fiber reinforced thermoplastics to fiber reinforced thermoplastics or metal through use of the present apparatus.

### DETAILED DESCRIPTION OF THE SEVERAL EMBODIMENTS

The detailed description set forth below in connection with the appended drawings is intended as a description of presently preferred embodiments of the system and does not represent the only forms in which the present system may be constructed and/or utilized. The description sets forth the functions and the sequence of steps for constructing and operating the system in connection with the illustrated embodiments.

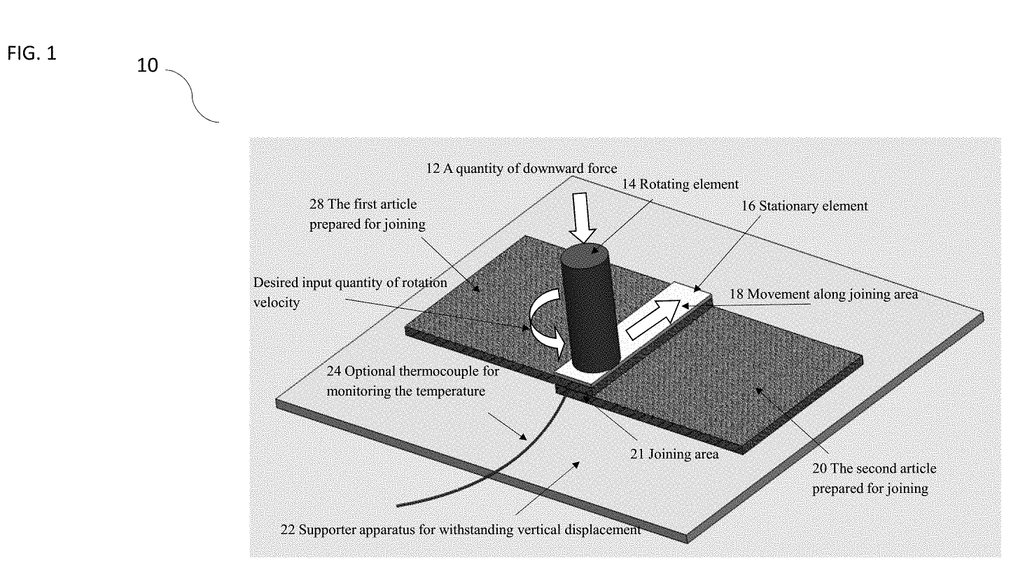

FIG. 1 illustrates a perspective view of a mechanical schematic of the operation of the joining method. Prior to joining, the first article prepared for joining 28 and the second article prepared for joining 20 are overlapped to form the joining area 21 which is covered by the stationary element 16. The stationary element 16 is temporarily fixed to ensure the joining area 21 is consistently covered by the stationary element 16 which furthermore will be removed from the joining area 21 after the joining process. The stationary element 16 comprises low cost materials with large thermal conductivity.

The joining process comprises the rotating element 14 rotating under a designated quantity of rotation velocity which approaches the stationary element 16. Heat is created as a result of the contact between the rotating element 14 and stationary element 16 through the deformation of the stationary element 16 and the friction between the rotating element 14 and the stationary element 16. The rotating element 14 comprises materials with high hardness value to reduce the friction wear. The aforementioned heat will soften the thermoplastic resin 38 in fiber reinforced thermoplastic articles adjacent to the rotating element 14. In one embodiment, fiber reinforced thermoplastic and fiber reinforced thermoplastics are joined due to the inter-diffusion between the polymer chains, and the fiber reinforced thermoplastic and metal are joined by forming metal-thermoplastic bonding.

A designated downward force 12 is subjected through the rotating element 14 to this soften region 40, which will induce an intimate contact between the first article of thermoplastic material 28 and the second article of thermoplastic material 20 within this soften region 40. Such intimate contact will reduce the amount of entrapped air between the first and the second article.

After a designated period of time, the rotating element 14 will leave this soften region 40 to move across the joining area 21 under a designated quantity of rotation velocity. The softened thermoplastic resin 40 cools down when rotating element 14 leaves, the softened thermoplastic resin 40 will solidify again resulting in an accomplished joining.

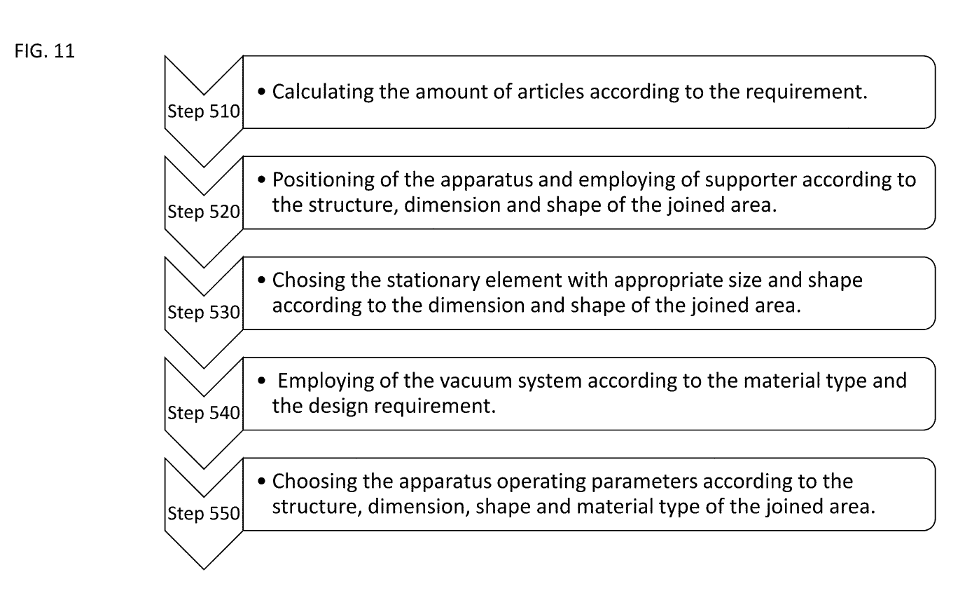

It should additionally be noted that utilization of a support mechanism underneath the joined area may be required in order to withstand the vertical displacement of the articles. In addition, the stationary element 16 may be subjected to deformation after joining, and said deformation resultants will be required to be removed from the accomplished joint and to be replaced in the next joining process. For pragmatic application of the overall process, the steps illustrated in FIG. 11 should be utilized in order to ensure a high quality joining.

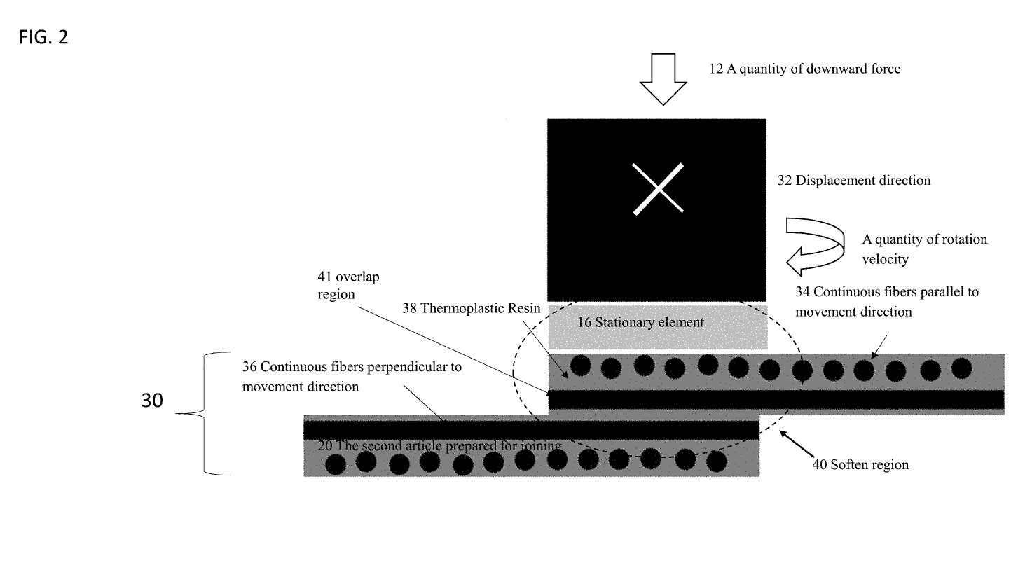

FIG. 2 illustrates a side view of a mechanical schematic of the joining process illustrating the joining of two continuously fiber reinforced thermoplastic articles 30. FIG. 2 further illustrates that the soften region 40 may not be identical to the overlapped region 41 between two articles. Furthermore, it is not necessary for the entire overlapped region 41 to be softened.

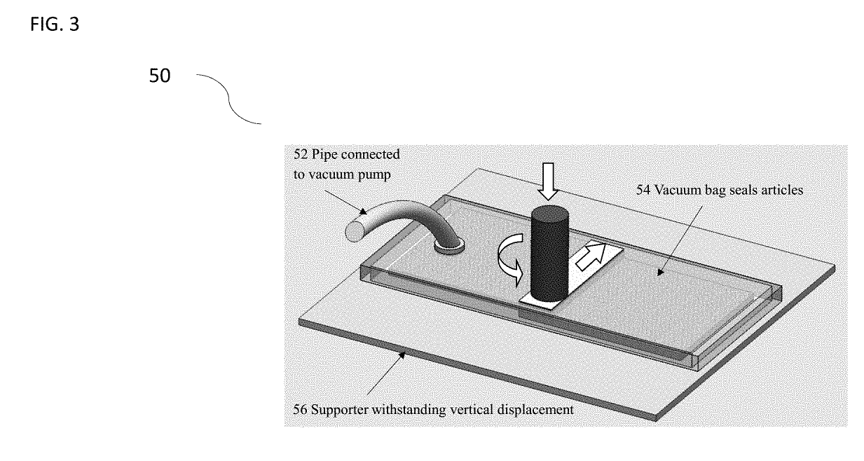

FIG. 3 illustrates a perspective view of a mechanical schematic of an alternative embodiment of the system and accompanying method shown in FIG. 1. In said embodiment, the joining process is best achieved by utilizing a vacuum environment 50. For some material combinations, the existence of oxygen will deteriorate the strength of joining. In this case, the joining process is preferred to be operated in the presence of vacuum. A vacuum bag 54, attached with a pipe connected to a vacuum pump 52, is used to seal the articles to ensure the joining process is operated in vacuum environment. The vacuum bag 54 can be made by a plurality of materials.

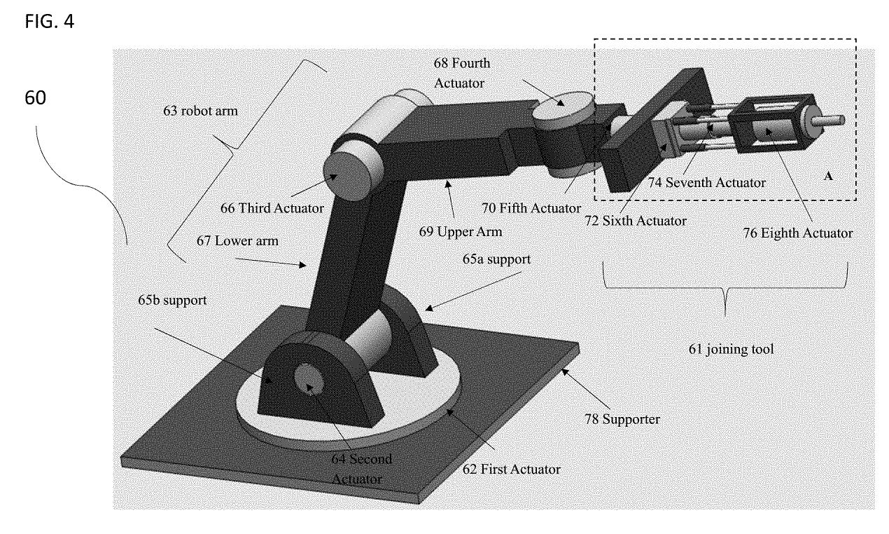

FIG. 4 illustrates a perspective view of the one embodiment of the instant system and apparatus for joining fiber reinforced thermoplastic to fiber reinforced thermoplastic and metal 60, and one embodiment, the apparatus comprises a joining tool 61, and a robotic arm 63. The purpose of utilizing the robotic arm 63 is to realize multiple degrees of freedom of joining tool movement which should be able to be in compliance with the geometry complexity of the joined articles.

The instant robotic arm mechanism 63 comprises a plurality or set of actuators that work in conjunction with numerous supporting structural elements. Each individual in the set of actuators serves an independent, and crucial, purpose to the overall function of the system. In several embodiments, the entire structure will be compact in order to exhibit a more flexible manner for a more versatile application. The overall base structure, or first supporting structural element 78 is in communication with the first actuator 62. The supports 65a and 65b are in communication with the first actuator 62, in perpendicular communication with the second actuator 64, and in further communication with the lower arm 67. The second actuator 64 comprises a rotation structure and operation and is in communication with the lower arm 67, moving the lower arm 67. The lower arm 67 is in further communication with the third actuator 66. The third actuator 66 is able to rotate and is in further communication with the upper arm 69 allowing for movement of the upper arm 69. The upper arm 69 is in communication with the fourth actuator 68 and the fifth actuator 70. The fifth actuator 70 is in communication with the joining tool 61.

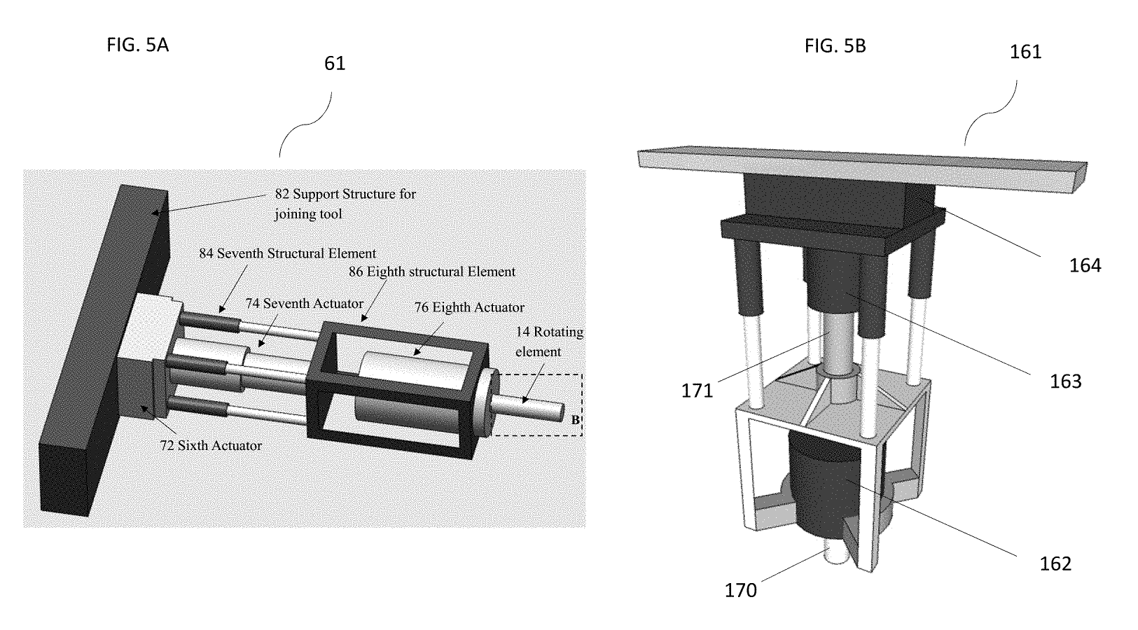

FIG. 5A illustrates an exploded view of the joining tool 61 for joining fiber reinforced thermoplastic to fiber reinforced thermoplastic and metal. The sixth actuator 72, accompanying with the support structure for the joining tool 82, enables an elaborate control of the displacement velocity of the rotating element 14 to move across the joining area. The seventh actuator 74, accompanying with the seventh structural element 84, enables an elaborate control of the downward force of the rotating element 14 subjected to the joining area. The eighth actuator 76, accompanying with the eighth structural element 86, enables an elaborate control of the rotation velocity of the rotating element 14. The chosen of aforementioned parameters of rotating element 14 as rotation velocity, downward force and displacement velocity are according to the structure, dimension and material type of the articles.

FIG. 5B illustrates an exploded view of an additional embodiment of the joining tool 161 which is the direct implement for joining fiber reinforced thermoplastic to fiber reinforced thermoplastic and, for joining fiber reinforced thermoplastic to metals, illustrating a three actuator alignment including a rotational actuator 162 for driving the rotation of any embodiment of rotation element 170 utilized to impart rotational forces to the bonding set, a vertical actuator 163 for subjecting downward force with vertical element 171 upon the rotation element and the bonding set, and a horizontal actuator 164 for subjecting relative displacement of the rotation element in relation to the bonding set.

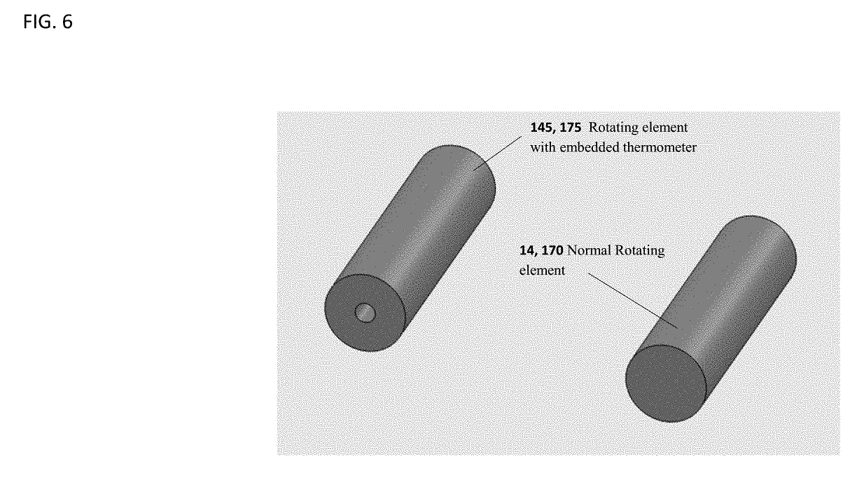

FIG. 6 illustrates a perspective view of two alternative embodiments of rotating elements 14 which may be utilized in conjunction with either embodiment of the joining tools 61, 161 illustrated herein, for driving the rotation of rotation element either the joining tool 61, 161, in order to introduce the respective rotating element 14, 170 to the bond set and stationary element or sacrificial piece. Additionally, the base embodiment rotating elements 14, 170 comprise a solid component.

In an alternative embodiment the of rotating elements 145, 175 respectively, a thermometer may be embedded directly into the rotating element and thus, very accurate temperature readings at the joining area may be yielded in conjunction with a constant monitoring process or system, in order to facilitate the optimization of joining process.

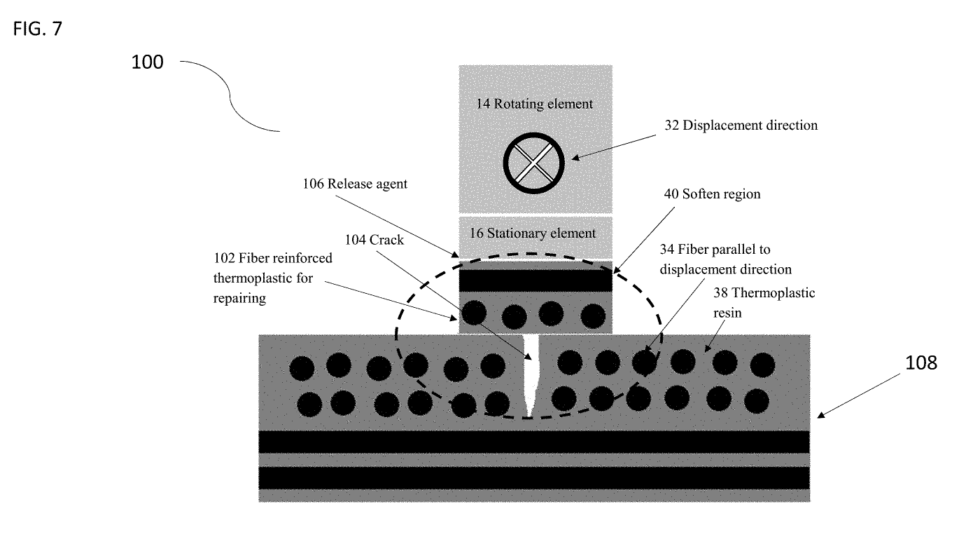

FIG. 7 illustrates a side view of a mechanical schematic of the first embodiment of the apparatus which is used for repairing defects and damage on fiber reinforced thermoplastic aero structures 100. This illustrates the first embodiment as the apparatus is used for repairing fiber reinforced thermoplastic aero structure 108 with cracks and damages 104. In this embodiment, the damaged aero structure 108 plays as the role of second article, while the first article is the fiber reinforced thermoplastic 102 used for repairing.

The entire first article 102 and part of the damaged aero structure 108 adjacent to the crack 104 and first article 102 are softened, which are further fused together to achieve the target of repairing. In this case supporter may not be necessary if the rest of aero structure 108 can withstand downward force with negligible displacement. The stationary element 16 should be temporarily fixated, and release agent 106 is suggested to be inserted between the stationary element 16 and the first article 102 to facilitate the removal of the stationary element 16.

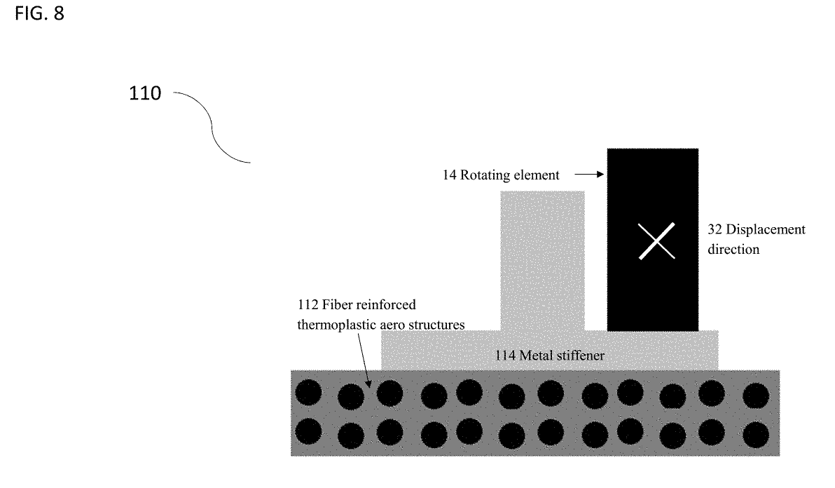

FIG. 8, illustrates a side view of a mechanical schematic of the second embodiment of the apparatus which is used for joining a metal stiffener feature to fiber reinforced thermoplastic aero structures 110. At least one Metal stiffener 114 are joined with fiber reinforced thermoplastic aero structures 112. In this embodiment, the stationary element 16 is optional, depending on the property of metal stiffeners 114 and joining parameters.

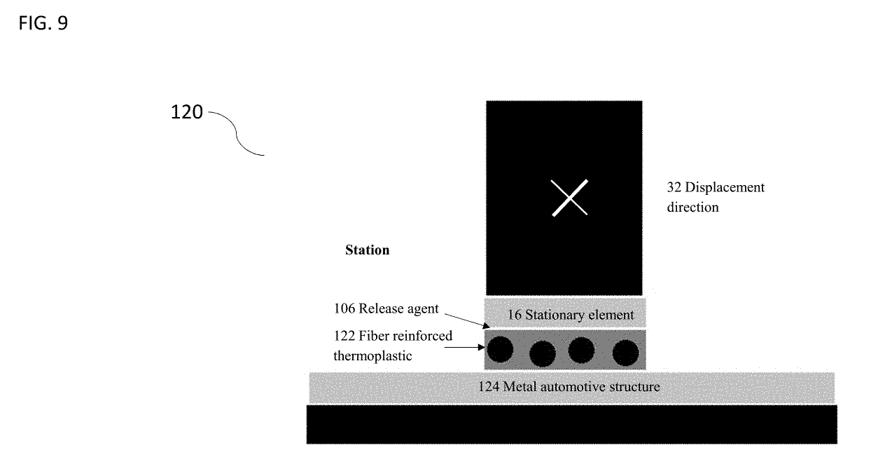

FIG. 9, illustrates a side view of a mechanical schematic of the third embodiment of the apparatus which is used for joining fiber reinforced thermoplastic to reinforced metal automotive structures 120, increasing the stiffness and strength of that structure. Fiber reinforced thermoplastic 122 is joined with the metal automotive structure 124 as the second article. The metal surface can be treated to facilitate the joining performance between metal and thermoplastic composite.

The stationary element 16 should be temporarily fixated or restrained, and the release agent 106 is suggested to be inserted between the stationary element 16 and the fiber reinforced thermoplastic 124 to facilitate the removal of the stationary element 16. The rotation velocity of the rotating element 14 should be elaborated to soften the fiber reinforced thermoplastic 122. An optional supporter of metal structure 126 may be required to withstand the downward force which may deform the metal structure.

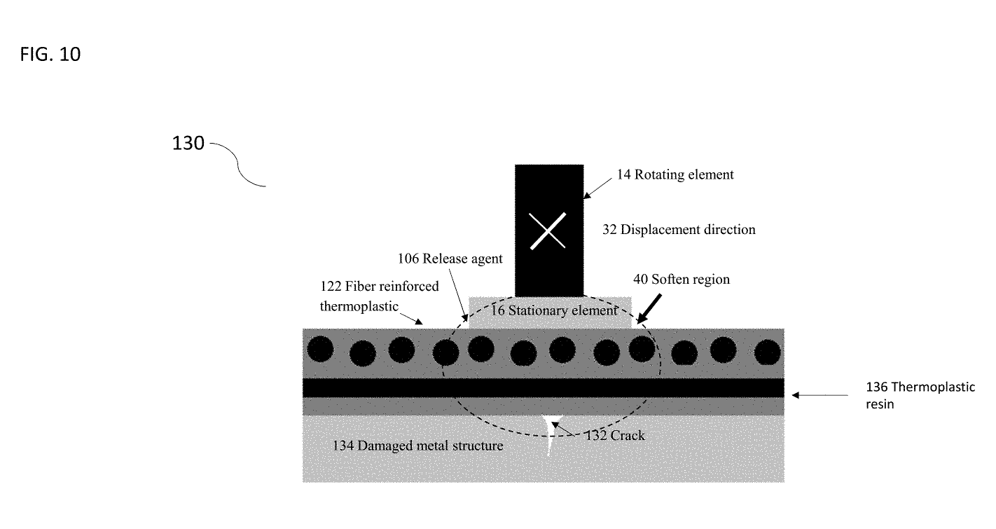

FIG. 10 illustrates a side view of a mechanical schematic of the fourth embodiment of the apparatus which is used for joining fiber reinforced thermoplastic to repair damaged metal civil structures 130. In this embodiment the damaged metal structure 134 is the second article, while the first article is the fiber reinforced thermoplastic 122 employed for repairing. The fiber reinforced thermoplastic 122 is softened, and the thermoplastic resin 136 in the first article will flow into the crack 132 and the undamaged metal surface will also bond with the fiber reinforced thermoplastic 122. The damaged metal structure 134 is thus reinforced by the joined fiber reinforced thermoplastic 122. In this case supporter may not be necessary if the metal structure 134 can withstand downward force with negligible displacement. The stationary element 16 should be temporarily fixated, and release agent 106 is suggested to be inserted between the stationary element 16 and the fiber reinforced thermoplastic 122 to facilitate the removal of the stationary element 16.

FIG. 11 illustrates a flow chart of the method for joining fiber reinforced thermoplastics to fiber reinforced thermoplastics or metal through use of the present apparatus. At step 510 the amount of articles is calculated, according to the requirement. At step 520 the positioning of the apparatus and the employment of supporter is decided according to the structure, dimension and shape of the joined area. At step 530 the stationary element is chosen with appropriate size and shape according to the dimension and shape of the joined area. At step 540 the employment of the vacuum system is decided according to the material type and the design requirement. At step 550 the apparatus operating parameters are chosen according to the structure, dimension, shape, and material type of the joined area.

What is claimed is:

1. An apparatus for joining fiber reinforced thermoplastic to fiber reinforced thermoplastic and metal comprising:
at least one joining tool comprising an at least one rotational element;
a robotic arm mechanism comprising at least three actuators and at least three supporting structural elements, wherein the at least three supporting structural elements are in communication with at least three actuators; and,
at least one stationary member.

2. The apparatus for joining fiber reinforced thermoplastic to fiber reinforced thermoplastic and metal of claim 1 further comprising at least one supporter structure.

3. A method of manufacturing a fiber-reinforced component utilizing the apparatus of claim 1, comprising the steps of:
calculating the amount of articles;
choosing a stationary member;
positioning of an apparatus;
choosing a supporter mechanism to be utilized according to the structure, dimension and shape of the joined area requirements;
employing the supporter mechanism;
employing the stationary member;
choosing a stationary element according to an appropriate size and shape according to the dimension and shape of the joined area;
employing the stationary element;
choosing a vacuum system according to the material type and the design requirement;
employing the vacuum system; and,
choosing a set of apparatus operating parameters selected from the parameter consisting of, a dimension, a shape, and a material type of the joined area;
wherein the choosing of the set of apparatus operating parameters is contingent upon to the structure to be joined.

4. A method for joining fiber reinforced thermoplastic to fiber reinforced thermoplastics and metals utilizing the apparatus of claim 1 comprising the steps of:
employing a rotating element;
contacting a stationary element under a certain velocity to generate heat to soften the fiber reinforced thermoplastic. The rotating velocity can be varied;
subjecting a force to the rotating element and stationary element to offer an intimate contact between the joining articles. The magnitude of force can be varied; and,
subjecting a variable displacement velocity to the rotating element.

5. The method for joining fiber reinforced thermoplastic to fiber reinforced thermoplastics and metals of claim 4 further comprising the step of:
displacing the rotating element across a joining area.

6. The method for joining fiber reinforced thermoplastic to fiber reinforced thermoplastic and metal of claim 5 wherein the joining process can be operated within a vacuum controlled atmosphere.

7. An apparatus for joining fiber reinforced thermoplastic to fiber reinforced thermoplastics and metals comprising:
a joining tool comprising a plurality of actuators and a plurality of supporting structures wherein the a plurality of actuators and the plurality of supporting structures are disposed to allow a rotating element to rotate under a specifically chosen velocity, to be subjected a specifically chosen force and to be moved under a specifically chosen displacement velocity.
a rotational element wherein the rotational element may be selected from the group consisting of a solid component and a component with thermometer embedded.
a robotic arm disposed to allow the joining tool to be moved in multiple degrees of freedom.
